(19) United States
(12) Patent Application Publication
(10) Pub. No.: US 2010/0110546 A1
(43) Pub. Date: May 6, 2010

(54) PHOTONICS DEVICE

(75) Inventors: Sahnggi PARK, Daejeon (KR); Kap-Joong Kim, Daejeon (KR); In-Gyoo Kim, Daejeon (KR); Gyungock Kim, Seoul (KR)

Correspondence Address: AMPACC Law Group, 3500 188th Street S.W., Suite 103, Lynnwood, WA, 98037, US

(73) Assignee: Electronics and Telecommunications Research Institute, Daejeon (KR)

(21) Appl. No.: 12/541,710

(22) Filed: Aug. 14, 2009

(30) Foreign Application Priority Data
Nov. 3, 2008 (KR) 10-2008-0108380

(51) Int. Cl. G02B 5/18

(52) U.S. Cl. 359/568

(57) ABSTRACT

Provided is a photonics device. The photonics device includes a distribution Bragg reflector (DBR), first and second waveguides disposed at both sides of the DBR, first lenses disposed between the DBR and the first waveguides, and second lenses disposed between the DBR and the second waveguides.

### CROSS-REFERENCE TO RELATED APPLICATIONS

This U.S. non-provisional patent application claims priority under 35 U.S.C. § 119 of Korean Patent Application No. 10-2008-010830, filed on Nov. 3, 2008, the entire contents of which are hereby incorporated by reference.

### BACKGROUND OF THE INVENTION

The present invention disclosed herein relates to a photonics device, and more particularly, to a multi-channel distribution Bragg reflector (DBR) filter.

In twenty-first century, optical communication technology has been highly developed, and much research is currently underway to apply optical communication technology to communication between computer boards, communication between chips of a board, or communication inside a complementary metal oxide semiconductor (CMOS) chip. In the case where optical signal communication technology is applied to a silicon very-large-scale-integration circuit (VLSI) chip, demerits of electric signal communication technology such as low-speed, high-resistance, excessive heat generation, and parasitic capacitance can be removed. Therefore, more research will be conducted on optical communication technology in semiconductor and information/communication fields.

Silicon optical waveguide devices such as silicon-based optical switches, optical modulators, and multiplexing/demultiplexing (MUX/DEMUX) filters are necessary to apply optical communication technology to silicon-based semiconductor chips. Since such optical switches, optical modulators, and MUX/DEMUX filters can be constituted using ring resonators or arrayed waveguide gratings (AWGs), much research is being conducted on the ring resonators or AWGs.

However, since a ring resonator or an AWG is highly sensitive to statistic errors caused by inevitable process condition variations, it is difficult to maintain wavelength spacing between channels of a ring resonator or an AWG at a constant level. Furthermore, since the ring resonator or the AWG includes a silicon waveguide of which the refractive index is largely dependent on temperature, a channel center wavelength can be largely varied even by a slight temperature variation. Moreover, since the ring resonator or the AWG has a minimum line width of about 100 nm, it is difficult to fabricate the ring resonator or the AWG stably through a photolithography process using an ArF excimer laser having a wavelength of 193 nm.

### SUMMARY OF THE INVENTION

The present invention provides a photonics device capable of multi-channel multiplexing/demultiplexing (MUX/DEMUX).

The present invention also provides a photonics device having improved inter-channel wavelength spacing characteristics.

The present invention also provides a photonics device in which a channel center wavelength is less dependent on temperature.

The present invention also provides a photonics device that can have stable characteristics even when fabricated using an ArF excimer laser.

Embodiments of the present invention provide photonics devices including: a distribution Bragg reflector (DBR); a plurality of first waveguides disposed at a side of the DBR; a plurality of second waveguides disposed at the other side of the DBR; first lenses disposed between the DBR and the first waveguides; and second lenses disposed between the DBR and the second waveguides.

In some embodiments, the DBR may include three cavities. In this case, each of the cavities may have a length that is N times greater than λ/2, where N denotes an integer and λ denotes a center channel wavelength (for example, 1550 nm). That is, the length of the cavity can be expressed by L=N(λ/2n cos θ) where L denotes the length of the cavity, θ denotes an incident angle at a center channel, n denotes a refractive index of the cavity.

In even other embodiments, each of the first and second waveguides may be used as one of a discharging waveguide configured to guide signal light toward the DBR and a receiving waveguide configured to receive signal light from the DBR. In this case, end-portions of the first waveguides used as the discharging waveguides may be arranged at different angles with the DBR, and end-portions of the second waveguides used as the discharging waveguides may be arranged at different angles with the DBR. This arrangement angle difference may have influence on wavelengths to be filtered.

In yet other embodiments, both sidewalls of the DBR facing the first and second waveguides may be substantially flat and are uniformly spaced from each other.

In further embodiments, end-portions of the first and second waveguides adjacent to the DBR may be configured as spot size converters. In addition, each of the first and second lenses may be used to collimate light traveling from one of the first and second waveguides toward the DBR or to focus light discharged from the DBR onto one of the first and second waveguides.

In even further embodiments, the photonics device may further include: a lower clad layer; lower core patterns disposed on the lower clad layer to define shapes of the first and second lenses and the DBR; an upper core layer disposed on the lower core patterns to form an optical waveguide between the first waveguides and the second waveguides; and an upper clad layer covering the upper core layer. In this case, the lower core patterns may be formed of a material having a refractive index greater than a refractive index of the upper core layer so as to increase an effective refractive index of the upper core layer, and the upper core layer may form a slab waveguide between the first waveguides and the second waveguide.

### BRIEF DESCRIPTION OF THE FIGURES

The accompanying figures are included to provide a further understanding of the present invention, and are incorporated in and constitute a part of this specification. The drawings illustrate exemplary embodiments of the present invention and, together with the description, serve to explain principles of the present invention. In the figures:

FIG. 1 is a plan view illustrating a multi-channel distribution Bragg reflector (DBR) filter according to an embodiment of the present invention;

FIG. 2 is a plan view illustrating one of the channel regions of the multi-channel DBR filter according to an embodiment of the present invention;

FIG. 3 is a plan view for explaining waveguides and lenses of the multi-channel DBR filter according to an embodiment of the present invention;

FIGS. 4 and 5 are sectional views illustrating a multi-channel DBR filter according to an embodiment of the present invention;

FIG. 6 is a plan view illustrating a DBR according to an embodiment of the present invention;

FIG. 7 is a graph showing a channel wavelength spectrum according to an embodiment of the present invention; and

FIG. 8 is a graph showing an eight-channel-wavelength spectrum according to an embodiment of the present invention.

### DETAILED DESCRIPTION OF PREFERRED EMBODIMENTS

Preferred embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

In the specification, the dimensions of layers and regions are exaggerated for clarity of illustration. It will also be understood that when a layer (or film) is referred to as being ‘on’ another layer or substrate, it can be directly on the other layer or substrate, or intervening layers may also be present. Also, though terms like a first, a second, and a third are used to describe various regions and layers in various embodiments of the present invention, the regions and the layers are not limited to these terms. These terms are used only to tell one region or layer from another region or layer. Therefore, a layer referred to as a first layer in one embodiment can be referred to as a second layer in another embodiment. An embodiment described and exemplified herein includes a complementary embodiment thereof.

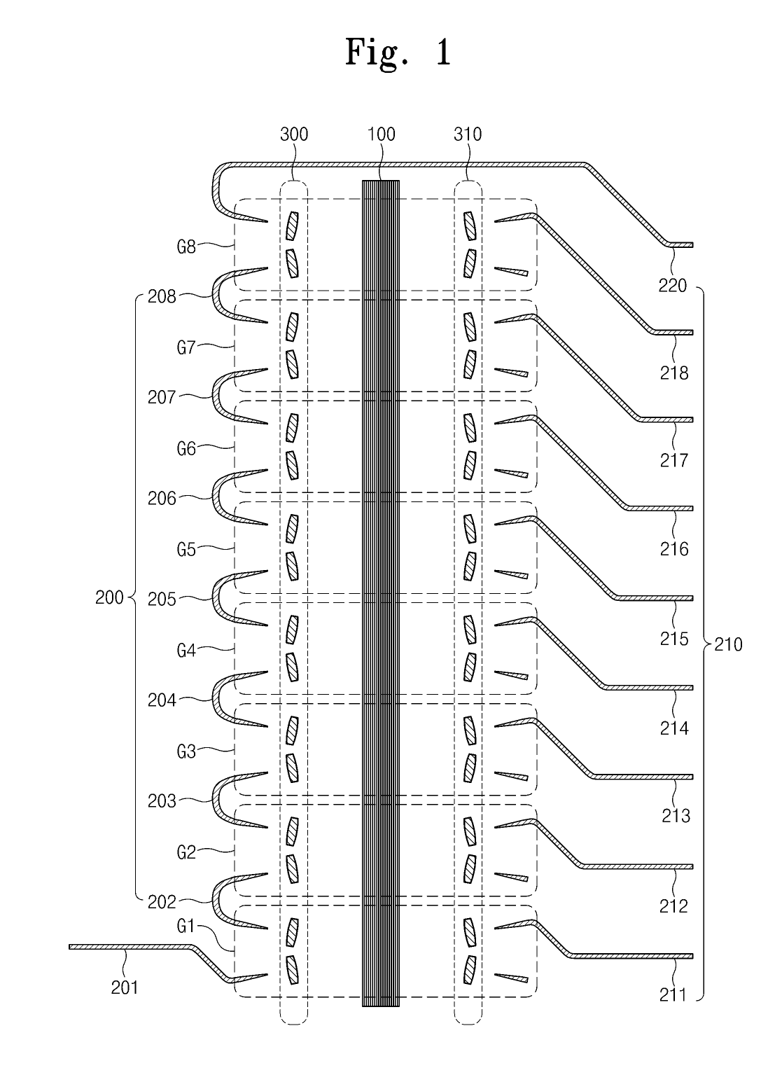

FIG. 1 is a plan view illustrating a multi-channel distribution Bragg reflector (DBR) filter according to an embodiment of the present invention.

Referring to FIG. 1, the multi-channel DBR filter of the current embodiment may include: a connection waveguide structure 200; an output waveguide structure 210; a DBR 100 disposed between the connection waveguide structure 200 and the output waveguide structure 210; and lens structures (300, 310) disposed among the connection waveguide structure 200, the DBR 100, and the output waveguide structure 210. In addition, an input waveguide 201 and a through-waveguide 220 may be disposed at sides of the connection waveguide structure 200.

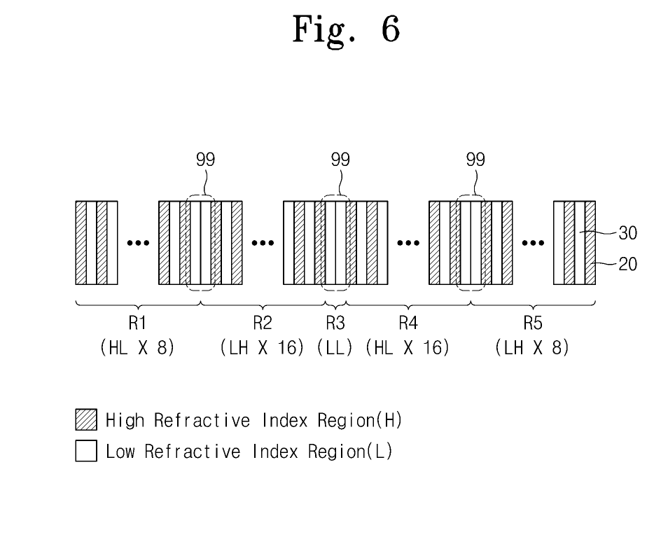

The DBR 100 includes high refraction regions and low refraction regions that are arranged in turns, and the widths of the high and low refraction regions may vary according to wavelengths of light to be selected. The DBR 100 will be described later in more detail with reference to FIGS. 5 and 6. In the current embodiment, the DBR 100 may be disposed between the connection waveguide structure 200 and the output waveguide structure 210 and have a uniform width (that is, the distance between both sidewalls of the DBR 100 may be uniform). In other words, both sidewalls of the DBR 100 may be flat along the whole length of the DBR 100.

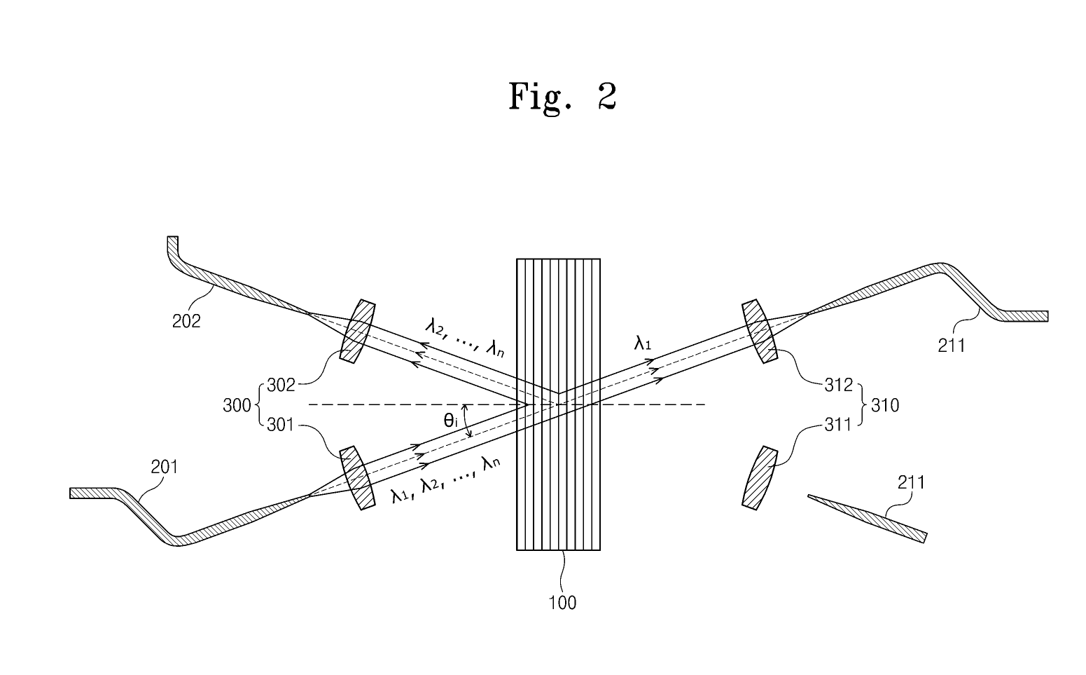

The lens structures may include a first lens structure 300 disposed at a side of the DBR 100 and a second lens structure 310 disposed at the other side of the DBR 100. The first lens structure 300 may include a plurality of first lenses arranged between the DBR 100 and the connection waveguide structure 200. The second lens structure 310 may include a plurality of second lenses arranged between the DBR 100 and the output waveguide structure 210. Technical characteristics of the first and second lenses will be described later in detail with reference to FIGS. 2 through 5.

The connection waveguide structure 200 includes a plurality of connection waveguides 202, 203, 204, 205, 206, 207, and 208 configured to connect the first lenses optically. Both end-portions of each of the connection waveguides 202 to 208 may be pointed toward the DBR 100 or the first lenses. For this, each of the connection waveguides 202 to 208 may be U-shaped. In the current embodiment of the present invention, the connection waveguides 202 to 208 may have different shapes so that both end-portions of the connection waveguides 202 to 208 are pointed toward the DBR 100 at different angles. Technical features of this structure will be described later in detail with reference to FIGS. 2 through 5.

The output waveguide structure 210 includes a plurality of output waveguides 211, 212, 213, 214, 215, 216, 217, and 218, which are configured to transmit signal light incident from the second lenses to other optical devices (not shown). An end-portion of one of the output waveguides 211 to 218 adjacent to one of the second lenses may be parallel with an end-portion of one of the input waveguide 201 and the connection waveguides 202 to 208 and may be disposed on an extension line of the end-portion of the one of the input waveguide 201 and the connection waveguides 202 to 208. This will be described later with reference to FIG. 2.

The multi-channel DBR filter of the current embodiment may be divided into a plurality of channel regions G1, G2, G3, G4, G5, G6, G7, and G8. Each of the channel regions G1 to G8 may include a pair of the first lenses, a pair of the second lenses, and a portion of the DBR 100 disposed therebetween. Each of the channel regions G1 to G8 may further include an end-portion of one of the connection waveguides 202 to 208 and an end-portion of one of the input waveguide 201 and the output waveguides 211 to 218. In the current embodiment of the present invention, the channel regions G1 to G8 may be configured such that input light including optical signals having different wavelength bands can be distributed to the different output waveguides 211 to 218. For this purpose, the lenses and waveguides constituting the channel regions G1 to G8 may have different geometric structures. One of the channel regions G1 to G8 will be exemplarily described in detail with reference to FIG. 2.

FIG. 2 is a detailed plan view illustrating one of the channel regions of the multi-channel DBR filter according to an embodiment of the present invention.

Referring to FIG. 2, the first lens structure 300 may include a pair of the first lenses 301 and 302 disposed among the DBR 100, the input waveguide 201, and the connection waveguide 202, and the second lens structure 310 may include a pair of the second lenses 311 and 312 disposed between the DBR 100 and the output waveguide 211. In another embodiment of the present invention, the second lens structure 310 may not include the second lens 311 but include the second lens 312 disposed on an extension line of an end-portion of the output waveguide 211.

In embodiments of the present invention, wavelengths (hereinafter also referred to as channel wavelengths) to be distributed to the output waveguides 211 to 218 through the channel regions G1 to G8 may be determined by the angle of incident of signal light on the DBR 100. In detail, if light incident onto the DBR 100 at right angle can pass through the DBR 100 when the light has a wavelength λo (reference wavelength), light incident onto the DBR 100 at an incident angle θ1 can pass through the DBR 100 when the light have a wavelength λ expressed by Equation 1 below.

λ˜λₒ cos θ1 [Equation 1]

Therefore, signal light can be selectively distributed by adjusting the angle of incident of the signal light. For this adjustment, optical paths formed by the first and second lenses 301, 302, 311, and 312, and end-portions of the input, connection, and output waveguides 201, 202, and 211 are angled with respect to the DBR 100 at different angles according to the channel regions G1 to G8. Table 1 below shows an exemplary angle-wavelength relationship for distributing a wavelength band of 1544 nm to 1588 nm to eight channels according to an embodiment of the present invention. In this embodiment, the angle-wavelength relationship is obtained by calculation using a Transfer matrix.

TABLE 1

| Channel | Angle (degrees) | wavelength (nm) |
|---|---|---|
| channel 1 | 10.31 | 1544 |
| channel 2 | 10.04 | 1546 |
| channel 3 | 9.77 | 1548 |
| channel 4 | 9.49 | 1550 |
| channel 5 | 9.20 | 1552 |
| channel 6 | 8.90 | 1554 |
| channel 7 | 8.60 | 1556 |
| channel 8 | 8.28 | 1558 |

Referring to FIG. 1 and Table 1, in the current embodiment, a 1544-nm wavelength λ1 of signal light is output through the output waveguide 211 of a channel 1, and wavelengths λ2 to λn of the signal light are reflected by the DBR 100 to the connection waveguide 202 through the first lens 302. Then, the wavelengths λ2 to λn are selectively output to the output waveguides 212 to 218 through the channel regions G1 to G8 in the same manner. Wavelengths of the signal light different from channel wavelengths λ1 to λ8 of the channel regions G1 to G8 may be transmitted to the through-waveguide 220 and processed by an optical device (not shown). The distribution of the wavelengths of the signal light is a demultiplexing (DEMUX) process.

On the other hand, in the current embodiment, signal light beams having wavelengths corresponding to the channel wavelengths λ1 to λ8 of the channel regions G1 to G8 can be incident onto the channel regions G1 to G8 through the output waveguides 211 to 218. In this case, optical signals having different wavelengths can be combined. This combining process of optical signals is a multiplexing (MUX) process.

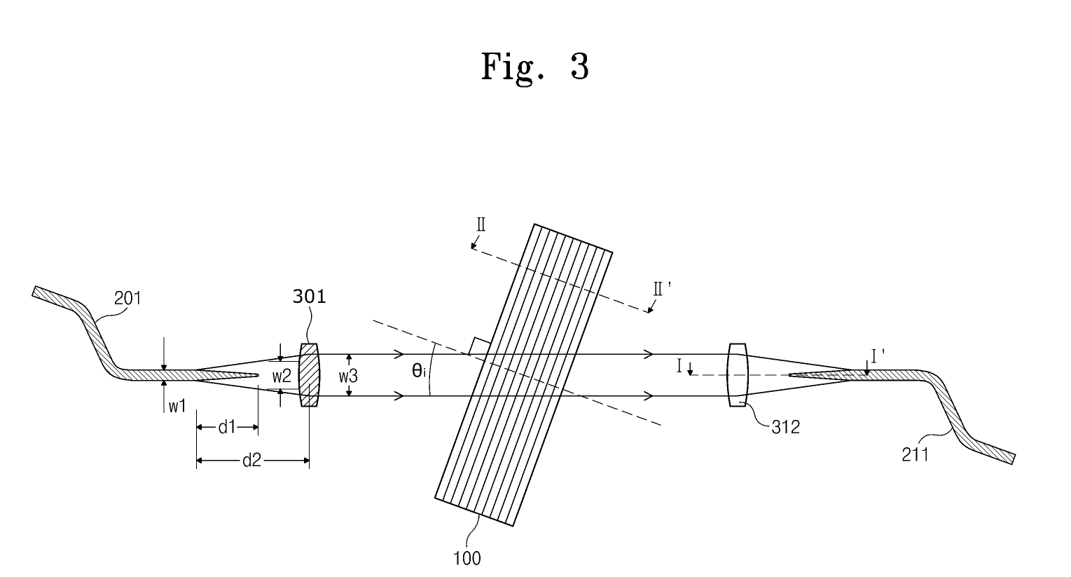

FIG. 3 is a plan view for explaining waveguides and lenses of the multi-channel DBR filter according to an embodiment of the present invention.

Referring to FIG. 3, in the current embodiment, end-portions of the waveguides of the multi-channel DBR filter may have a spot size converter structure. In detail, as shown in FIG. 3, the end-portions of the waveguides 201 and 211 may be tapered toward the DBR 100. In this case, an optical beam output from the input waveguide 201 may diverge to a width w2 greater than a width w1 of the input waveguide 201 as shown in FIG. 3.

The first lens 301 is configured to collimate light emitted from the spot size convert structure; that is, the diverged optical beam emitted from the spot size convert structure is collimated by the first lens 301 and is converted into a parallel optical beam having a width w3. For this end, the first lens 301 may be a two-dimensional convex lens.

The second lens 312 focuses the parallel optical beam received from the first lens 301 onto the output waveguide 211. For this, the second lens 312 may be a two-dimensional convex lens like the first lens 301. However, it may be unnecessary that the first and second lenses 301 and 312 have the same shape. For example, if the distance between the first lens 301 and the input waveguide 201 is different from the distance between the second lens 312 and the output waveguide 211, the first and second lenses 301 and 312 may have different sizes or surface curvatures. This difference or modification may be apparent to those of ordinary skill in the art.

Table 2 below shows exemplary geometric sizes and related features of a propagating beam, a lens, and a waveguide according to an embodiment of the present invention. These geometric sizes (dimensions) are obtained by computer modeling. In the present invention, however, the geometric sizes can be variously changed. That is, the present invention is not limited to the geometric sizes of Table 2.

TABLE 2

| | | |
|---|---|---|
| Waveguide width (w1) | 0.560 | μm |
| Beam width (w2) at end of waveguide | 3.41 | μm |
| Parallel beam width (w3) | 5.232 | μm |
| Length (d1) of tapered end portion of waveguide | 6.1 | μm |
| Distance (d2) between waveguide and lens | 10 | μm |

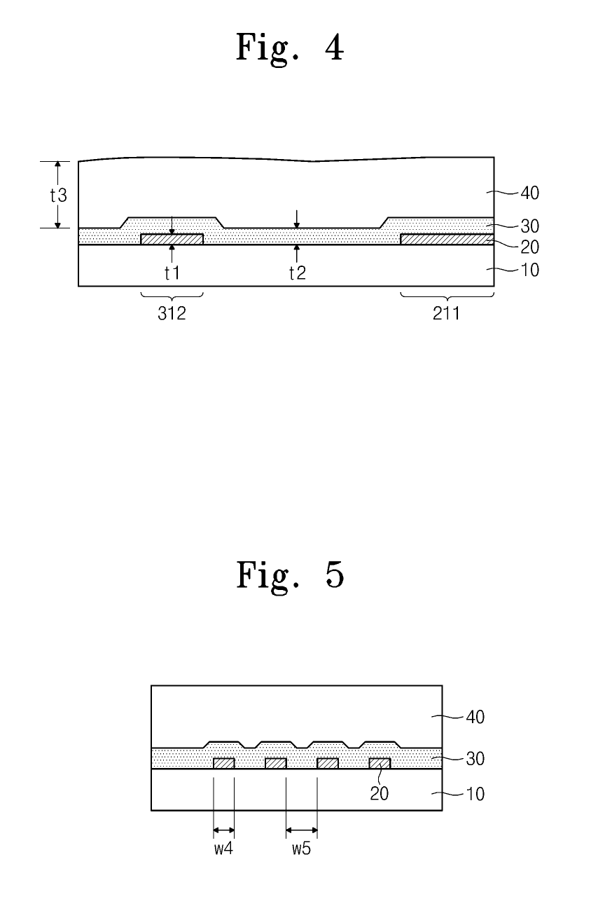

FIGS. 4 and 5 are sectional views illustrating the multi-channel DBR filter according to an embodiment of the present invention. FIG. 4 is a sectional view taken along line I-I′ of FIG. 3, and FIG. 5 is a sectional view taken along line II-II′ of FIG. 3. That is, FIG. 4 illustrates sections of the second lens 312 and a portion of the output waveguide 211, and FIG. 5 illustrates a section of the DBR 100.

Referring to FIGS. 4 and 5, an upper core layer 30 and an upper clad layer 40 are sequentially disposed on a lower clad layer 10. Lower core patterns 20 20 are disposed between the lower clad layer 10 and the upper core layer 30. The lower core patterns 20 include the connection waveguide structure 200, the output waveguide structure 210, the input waveguide 201, the through-waveguide 220, the first lens structure 300, and the second lens structure 310.

The upper core layer 30 is formed of a material having a refractive index higher than refractive indexes of the lower clad layer 10 and the upper clad layer 40, so as to form a slab waveguide. The lower core patterns 20 including waveguides and lenses as described above may be formed of a material having a refractive index higher than the refractive index of the upper core layer 30. For example, the lower clad layer 10, the lower core patterns 20, the upper core layer 30, and the upper clad layer 40 may be formed of silicon oxide, silicon, silicon nitride, and silicon oxide, respectively. The thicknesses t1, t2, and t3 of the lower core patterns 20, the upper core layer 30, and the upper clad layer 40 may be about 2200 Å, 4000 Å, and 2 μm, respectively.

In this case, the refractive indexes of the lower clad layer 10, the upper core layer 30, and the upper clad layer 40 may be about 1.45, 2.0, and 1.45, respectively. The effective refractive index of the lower core patterns 20 may be about 2.27, and the effective refractive index of the upper core layer 30 may be about 1.65 when the thickness t2 of the upper core layer 30 is about 4000 Å.

In the current embodiment, an optical signal may be vertically guided by the upper core layer 30. In addition, the horizontal shape of the optical signal is varied at an end portion of the second lens 312 or the output waveguide 211 according to the shapes and arrangement of the lower core patterns 20.

Referring to FIG. 5, the DBR 100 includes high refraction regions and low refraction regions that are arranged in turns. In an embodiment of the present invention, the upper core layer 30 forms the low refraction regions, and the lower core patterns 20 form the high refraction regions.

The sum of the width w4 of the high refraction region and the width w5 of the low refraction region may be about ½ of a wavelength (λ/2). For example, when a channel wavelength is 1550 nm, the width w4 of the high refraction region and the width w5 of the low refraction region may be about 160 nm and 230 nm, respectively. In this case (channel wavelength=1550 nm), the lower core patterns 20 may be disposed in a manner such that the incident angle of light on the DBR 100 can be about 9.49° as described above.

In a typical ring resonator filter, the distance between two waveguides forming an optical coupling region is about 100 nm. Therefore, it is difficult to guarantee the distance between the two waveguides in the case where the typical ring resonator filter is fabricated through a photolithography process using an ArF excimer laser having a wavelength of 193 nm. However, as explained above, in the current embodiment, since the minimum line width (minimum distance) of the patterns forming the DBR 100 is the width w4 (that is, about 160 nm) of the high refraction regions, the minimum line width can be surely guaranteed as compared with the case of the typical ring resonator filter.

In the case of an arrayed waveguide grating (AWG) (filtering device), waveguide length differences are used for filtering. Therefore, the AWG has a relatively large effective area as compared with that of the DBR filter or a typical ring resonator filter. That is, the DBR filter of the present invention can have an effective area similar to that of a typical ring resonator filter, while providing more stable optical characteristics than the typical ring resonator filter.

FIG. 6 is a plan view illustrating a DBR according to an embodiment of the present invention.

Referring to FIG. 6, the DBR of the current embodiment may include a plurality of region clusters that are sequentially and continuously arranged. Each of the region clusters may include high refraction regions (H) and low refraction regions (L) that are arranged in turns, or each of the region clusters may include a pair of low refraction regions (L).

In an embodiment, the DBR includes first to fifth region clusters R1 to R5 that are sequentially and continuously arranged. As shown in FIG. 6, each of the first and fourth region clusters R1 and R4 may include high refraction regions (H) and low refraction regions (L) that are arranged sequentially and alternately. Each of the second and fifth region clusters R2 and R5 may include low refraction regions (L) and high refraction regions (H) that are arranged sequentially and alternately. The third region cluster R3 may include a pair of low refraction regions (L) 99.

In this case, low refraction regions 99 are disposed between the first and second region clusters R1 and R2 and between the fourth and fifth region clusters R4 and R5, respectively, and therefore, totally, three pairs of low refraction regions 99 are arranged.

Since the sum of the width w4 of the high refraction region (H) and the width w5 of the low refraction region (L) is ½ of a wavelength (λ/2) as described above, an optical mirror structure can be formed. On the other hand, the pair of low refraction regions 99 forms a λ/2 cavity. That is, in the current embodiment, the DBR has three cavities.

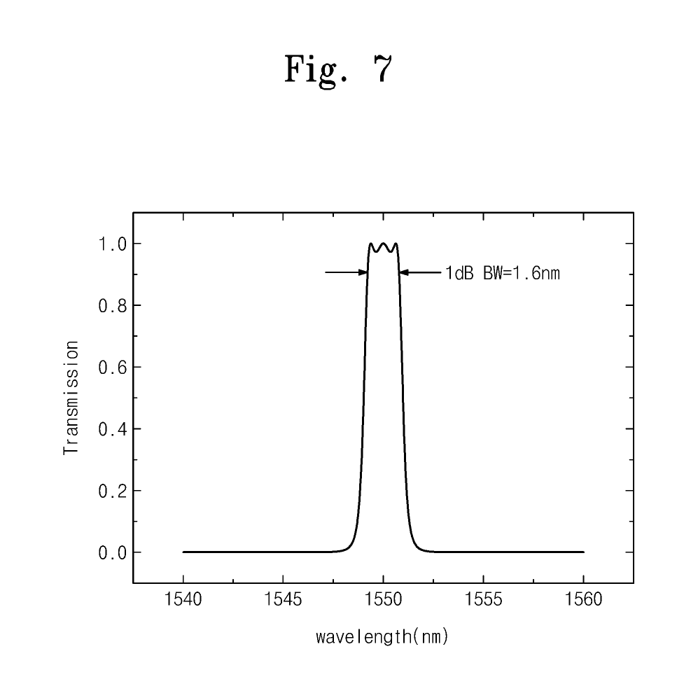

In other embodiments, the DBR may have one cavity or two cavities. In theses cases, however, it is difficult to obtain a desirable spectrum such as a rectangular shaped spectrum of FIG. 7 which was obtained by simulating the case where the DBR has three cavities.

In other embodiments, the DBR may have four or more cavities. In these cases, however, since the area of the DBR increases with the number of cavities, it may be less efficient as compared with the case where the DBR has three cavities.

In other embodiments, the length (width) of the cavity of the DBR may be nλ/2 (where n is a natural number equal to or greater than 2) such as 1λ and 3λ/2. However, in the present invention, since signal light is incident from each of the channel regions G1 to G8 onto the DBR at an oblique angle, according to simulation results, the spectrum of the signal can be distorted with increased ripples in the case where the length of the cavity has a value greater than λ/2 such as 1λ or 3λ/2. Here, λ denotes the wavelength of a center channel (for example, 1550 nm). The length of the cavity may be expressed by L=N(λ/2n cos θ) where N denotes a natural number such as 1, 2, 3, and 4, θ denotes the incident angle at the center channel, and n denotes the refractive index of the cavity.

In another embodiment, the first, second, fourth, and fifth region clusters R1, R2, R4, and R5 may include eight pairs, 16 pairs, 16 pairs, and 8 pairs of high and low refraction regions (H) and (L), respectively. The number of pairs may be varied according to a filter bandwidth.

FIG. 7 is a graph showing a channel wavelength spectrum according to an embodiment of the present invention. FIG. 7 shows a channel wavelength spectrum including a 1550-nm channel wavelength, which was obtained by performing a computer simulation using a transfer matrix on a multi-channel DBR filter including the DBR of FIG. 6. As shown in FIG. 7, a transmission bandwidth was about 1.6 nm, and ripples were smaller than about 0.2 dB. Therefore, it may be understood from the simulation results that the multi-channel DBR filter of the present invention has good spectrum characteristics.

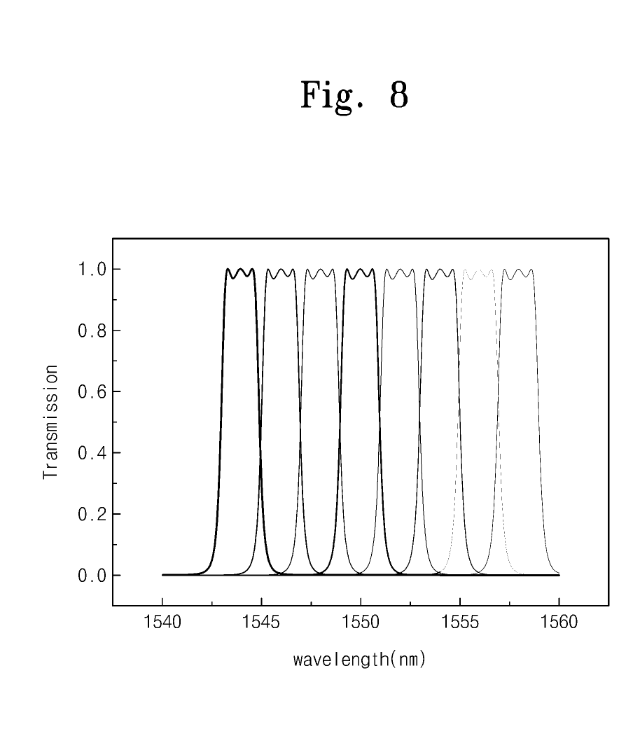

FIG. 8 is a graph showing an eight-channel-wavelength spectrum according to an embodiment of the present invention. The graph of FIG. 8 was obtained by performing a computer simulation using a transfer matrix on the multi-channel DBR filter shown in FIG. 1. Referring to FIG. 8, although the incident angle of light varied with the channel regions G1 to G8, substantially the same spectrum characteristics are presented at the respective channel regions G1 to G8 of the multi-channel DBR filter. Therefore, the multi-channel DBR filter of the present invention can be used for constituting a multi-channel multiplexing/demultiplexing filter.

The multi-channel DBR filter described in the above embodiments can be used as a multiplexing/demultiplexing device as mentioned above, and can also be used for constituting an optical switch and an optical modulator. It will be apparent to those skilled in the art that such modifications and variations can be made in the present invention.

As described above, since the refractive index of silicon is largely dependent on temperature, in the case of a ring resonator filter or AWG including filtering silicon patterns, a channel center wavelength is largely varied with temperature at about 6 nm/100° C. However, since the refractive index of a silicon nitride is less varied with temperature at a rate equal to or less than ⅕ that of silicon, the multi-channel DBR filter of the present invention, which includes a waveguide formed of a silicon nitride layer, can have a channel center wavelength that is less variable with temperature (at about 1.7 nm/100° C.) as compared with a ring resonator filter or AWG.

Furthermore, according to the present invention, since the minimum line width or spacing of patterns of the multi-channel DBR filter (the length of a high refraction region) is about 160 nm, the minimum line width can be stably maintained when the multi-channel DBR filter is fabricated through a photolithography process using an ArF excimer laser having a wavelength of 193 nm. In addition, the multi-channel DBR filter can have an effective area which is similar to that of a typical resonator filter but much smaller than that of an AWG (filtering device).

In the case of a ring resonator filter or an AWG, inter-channel wavelength spacing is dependent on the size and distance of patterns which are largely varied according to variation errors of manufacturing processes. Therefore, the inter-channel wavelength spacing of the ring resonator filter or AWG is sensitively varied according to statistic errors caused by manufacturing process condition errors.

However, in the case of the multi-channel DBR filter of the present invention, each channel wavelength is dependent on the incident angle of signal light which is determined by orientations of lenses or waveguides. Since the orientations of the lenses or waveguides are not sensitive to variation errors of a manufacturing process because the lenses or waveguides are formed through a transferring process using a photomask, the multi-channel DBR filter of the present invention is relatively less affected by statistic errors caused by manufacturing process errors. For example, even when the size of a lens of the multi-channel DBR filter is varied due to a process error, this variation does not affect inter-channel wavelength spacing significantly although it can affect the intensity of an output signal. Therefore, the multi-channel DBR filter of the present invention can have good inter-channel wavelength spacing characteristics even when there are statistic errors.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A photonics device comprising:
a distribution Bragg reflector (DBR);
a plurality of first waveguides disposed at a side of the DBR;
a plurality of second waveguides disposed at the other side of the DBR;
first lenses disposed between the DBR and the first waveguides; and
second lenses disposed between the DBR and the second waveguides.

2. The photonics device of claim 1, wherein the DBR comprises three cavities.

3. The photonics device of claim 2, wherein each of the cavities has a length expressed by the following equation:
L=N(λ/2n cos θ)
where L denotes the length of the cavity, N denotes a natural number, θ denotes an incident angle at a center channel, n denotes a refractive index of the cavity, and λ denotes a wavelength of the center channel.

4. The photonics device of claim 2, wherein each of the cavities has a length expressed by the following equation:
L=λ/2n cos θ
where L denotes the length of the cavity, θ denotes an incident angle at a center channel, n denotes a refractive index of the cavity, and λ denotes a wavelength of the center channel.

5. The photonics device of claim 1, wherein each of the first and second waveguides is used as one of a discharging waveguide configured to guide signal light toward the DBR and a receiving waveguide configured to receive signal light from the DBR,
end-portions of the first waveguides used as the discharging waveguides are arranged at different angles with the DBR, and
end-portions of the second waveguides used as the discharging waveguides are arranged at different angles with the DBR.

6. The photonics device of claim 1, wherein both sidewalls of the DBR facing the first and second waveguides are substantially flat and are uniformly spaced from each other.

7. The photonics device of claim 1, wherein end-portions of the first and second waveguides adjacent to the DBR are configured to form spot size converters.

8. The photonics device of claim 1, wherein each of the first and second lenses is used to collimate light traveling from one of the first and second waveguides toward the DBR or to focus light discharged from the DBR onto one of the first and second waveguides.

9. The photonics device of claim 1, further comprising:
a lower clad layer;
lower core patterns disposed on the lower clad layer to define shapes of the first and second lenses and the DBR;
an upper core layer disposed on the lower core patterns to form an optical waveguide between the first waveguides and the second waveguides; and
an upper clad layer covering the upper core layer,
wherein the lower core patterns are formed of a material having a refractive index greater than a refractive index of the upper core layer so as to increase an effective refractive index of the upper core layer.

10. The photonics device of claim 9, wherein the upper core layer forms a slab waveguide between the first waveguides and the second waveguide.
